(19) United States
(12) Patent Application Publication
(10) Pub. No.: US 2019/0011915 A1
(43) Pub. Date: Jan. 10, 2019

(54) DRIVING ASSISTANCE DEVICE, DRIVING ASSISTANCE METHOD, AND DRIVING ASSISTANCE PROGRAM

(71) Applicant: AISIN SEIKI KABUSHIKI KAISHA, Kariya-shi (JP)

(72) Inventor: Hideaki YAMAGUCHI, Okazaki-shi (JP)

(73) Assignee: AISIN SEIKI KABUSHIKI KAISHA, Kariya-shi (JP)

(21) Appl. No.: 16/021,109

(22) Filed: Jun. 28, 2018

(30) Foreign Application Priority Data
Jul. 4, 2017 (JP) 2017-130877

(51) Int. Cl. G05D 1/00; B60W 50/16; B60W 30/182

(52) U.S. Cl. CPC G05D 1/0061; G05D 1/0088; G05D 2201/0213; B60W 30/182; B60W 50/16

(57) ABSTRACT

A driving assistance device includes a driving control unit which switches control of a moving object between a self-driving period for controlling driving of the moving object and an authority transfer period between the self-driving period and a manual driving period during which a driver drives the moving object, and a vibration control unit which switches, by controlling a vibration application unit which applies a vibration to the driver, vibrations applied to the driver between the self-driving period and the authority transfer period.

### CROSS REFERENCE TO RELATED APPLICATIONS

This application is based on and claims priority under 35 U.S.C. § 119 to Japanese Patent Application 2017-130877, filed on Jul. 4, 2017, the entire content of which is incorporated herein by reference.

### TECHNICAL FILED

This disclosure generally relates to a driving assistance device, a driving assistance method, and a driving assistance program.

### BACKGROUND DISCUSSION

A known device that assists driving by performing self-driving of a moving object, such as an automobile, is disclosed in JP-H6-219227A (Patent Reference 1). In addition, a known technology for awakening a driver who is driving is disclosed in Hideaki Yamaguchi, et al., “Effects of Vibratory Simulation-Induced Kinesthetic Illusions on Driver's Drowsiness”, Proceedings of Technical Session presentations in 2016 JSAE Annual Congress (Spring), Society of Automotive Engineers of Japan, May 2016, No. 67-16S, p. 1671 to 1676 (Non-Patent Reference 1).

However, there is a problem that it is impossible to put a driver in an appropriate state during each of a self-driving period and an authority transfer period in which authority of driving is transferred from the one for self-driving to the one for manual driving.

A need thus exists for a driving assistance device, a driving assistance method, and a driving assistance program which are not susceptible to the drawback mentioned above.

### SUMMARY

According to an aspect of this disclosure, a driving assistance device of this disclosure includes: a driving control unit which switches control of a moving object between a self-driving period for controlling driving of the moving object and an authority transfer period between the self-driving period and a manual driving period during which a driver drives the moving object; and a vibration control unit which, by controlling a vibration application unit which applies a vibration to the driver, switches vibrations applied to the driver between the self-driving period and the authority transfer period.

According to another aspect of this disclosure, a driving assistance method includes: switching control of a moving object between a self-driving period for controlling driving of the moving object and an authority transfer period between the self-driving period and a manual driving period during which a driver drives the moving object; and switching vibrations applied to the driver between the self-driving period and the authority transfer period by controlling a vibration application unit which applies a vibration to the driver.

According to a further aspect of this disclosure, a computer program product including programmed instructions embodied in and stored on a non-transitory computer readable medium, wherein the instructions, when executed by a computer, cause the computer to perform switching control of a moving object between a self-driving period for controlling driving of the moving object and an authority transfer period between the self-driving period and a manual driving period during which a driver drives the moving object, and switching vibrations applied to the driver between the self-driving period and the authority transfer period by controlling a vibration application unit which applies a vibration to the driver.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating the inside of a vehicle on which a driving assistance system of an embodiment is mounted;

FIG. 2 is a block diagram describing a hardware configuration of a control system of the driving assistance system which is mounted on the vehicle;

FIG. 3 is a side view describing an arrangement and functions of vibration application units;

FIG. 4 is a front view describing the arrangement and the functions of the vibration application units;

FIG. 5 is a diagram illustrating a relationship between a vibration applied to an upper portion of the back and a cervical portion of a person and a variation amount of heat dissipation activity;

FIG. 6 is a diagram illustrating a relationship between a vibration applied to a rear surface of the buttocks of a person and the variation amount of heat dissipation activity;

FIG. 7 is a diagram illustrating a relationship between a vibration applied to inner portions of the thighs of a person and the variation amount of heat dissipation activity;

FIG. 8 is a diagram illustrating a relationship between a vibration applied to flank portions of a person and the variation amount of heat dissipation activity;

FIG. 9 is a diagram illustrating a relationship between a vibration applied to side surfaces of the buttocks of a person and the variation amount of heat dissipation activity;

FIG. 10 is a functional block diagram describing functions of a driving assistance device;

FIG. 11 is a timing diagram describing switching of application of vibrations to a driver by a vibration control unit; and

FIG. 12 is a flowchart of driving assistance processing performed by a processing unit.

### DETAILED DESCRIPTION

Common reference numbers are assigned to equivalent components in the following exemplary embodiment and the like, and an overlapping description thereof will be appropriately omitted.

### Embodiment

A first embodiment disclosed here will be explained with reference to the attached drawings.

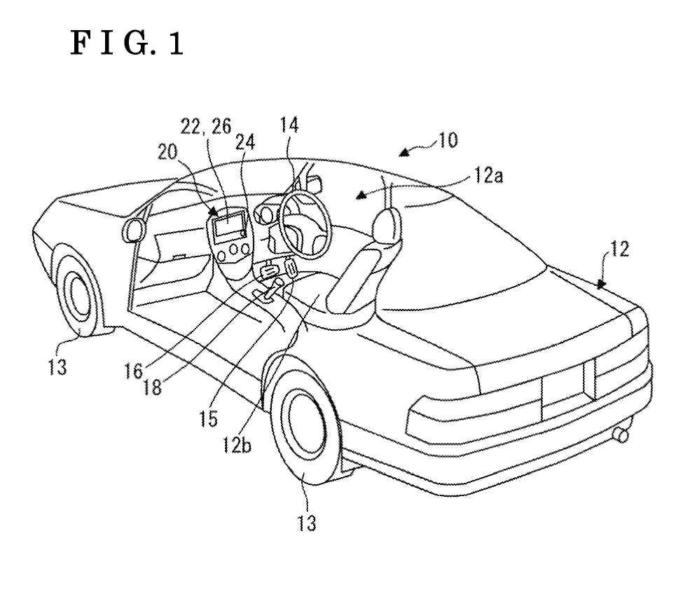

FIG. 1 is a perspective view illustrating the inside of a vehicle 10 on which a driving assistance system of an embodiment is mounted. The vehicle 10 is an example of a moving object. The vehicle 10 may be an automobile using an internal-combustion engine, such as an engine, as a drive source, an automobile using an electric motor, such as a motor, as a drive source, or a hybrid automobile using both thereof as drive sources, for example. On the vehicle 10, not only various types of transmission devices but also various types of devices (systems, components, and the like) required for driving an internal-combustion engine or an electric motor may be mounted. Methods, the number, a layout, and the like of devices involved in driving of wheels 13 of the vehicle 10 may be variously set.

As illustrated in FIG. 1, the vehicle 10 includes a body 12, four wheels 13, a steering unit 14, an acceleration unit 15, a braking unit 16, a transmission unit 18, and a monitor device 20.

The body 12 forms a vehicle interior 12a in which a not-illustrated passenger rides. The body 12 contains and holds the steering unit 14, the acceleration unit 15, the braking unit 16, the transmission unit 18, the monitor device 20, and the like in the vehicle interior 12a.

The four wheels 13 include two front wheels 13 and two rear wheels 13. The front wheels 13, for example, function as turning wheels that are turned by the steering unit 14. The rear wheels 13, for example, function as driving wheels that are rotated by the drive source.

The steering unit 14 is, for example, a steering wheel or a steering handle that sticks out from a dashboard. The steering unit 14 accepts an operation from a driver relating to a rightward or leftward direction of movement and changes a direction of the turning wheels (for example, the front wheels 13).

The acceleration unit 15 is, for example, an accelerator pedal that is positioned at the foot of a driver. The acceleration unit 15 accepts an operation from the driver relating to acceleration and accelerates the vehicle 10.

The braking unit 16 is, for example, a brake pedal that is positioned at the foot of a driver. The braking unit 16 accepts an operation from the driver relating to deceleration and decelerates the vehicle 10.

The transmission unit 18 is, for example, a shift lever that sticks out from a center console. The transmission unit 18 accepts an operation from a driver relating to a forward or rearward direction of movement and a transmission gear ratio and switches the forward and rearward directions of movement and the like of the vehicle 10.

The monitor device 20 is, for example, placed at a central portion in the vehicle width direction, that is, the crosswise direction, on the dashboard. The monitor device 20 may, for example, have a function of a navigation system, an audio system, or the like. The monitor device 20 includes a display device 22, a sound output device 24, and an operation input unit 26. The monitor device 20 may include a not-illustrated operation input unit, such as a switch, a dial, a joystick, and a push button.

The display device 22 displays an image, based on image information. The display device 22 is, for example, a liquid crystal display (LCD), an organic electroluminescent display (OELD), or the like.

The sound output device 24 outputs a sound, based on sound data. The sound output device 24 is, for example, a speaker. The sound output device 24 may be placed at a position different from the position of the monitor device 20 in the vehicle interior 12a.

The operation input unit 26 accepts inputs from users including a passenger and the driver. The operation input unit 26 is placed on a face of the display side of the display device 22. The operation input unit 26 is, for example, a touch panel that is capable of transmitting an image displayed on the display device 22. The operation input unit 26 accepts an instruction that a user inputs by touching a position corresponding to an image displayed on the display screen of the display device 22.

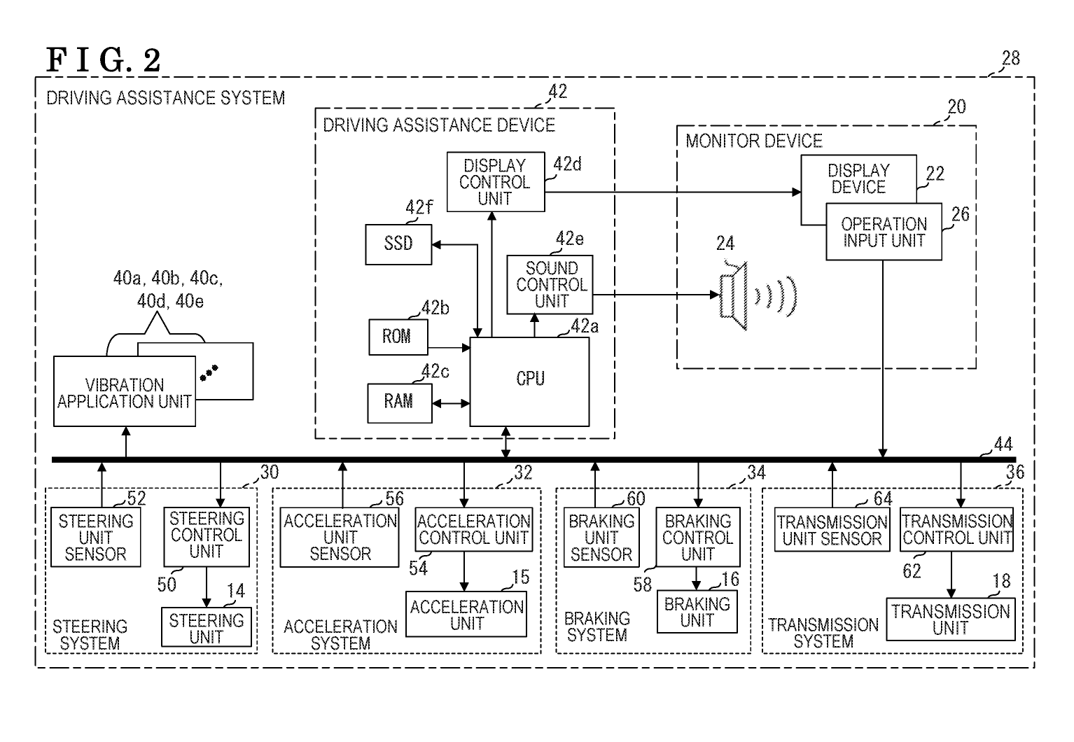

FIG. 2 is a block diagram describing a hardware configuration of a control system of a driving assistance system 28 that is mounted on the vehicle 10. As illustrated in FIG. 2, the driving assistance system 28 includes the monitor device 20, a steering system 30, an acceleration system 32, a braking system 34, a transmission system 36, a plurality (for example, five) of vibration application units 40a, 40b, 40c, 40d, and 40e, a driving assistance device 42, and an intra-vehicle network 44. When being not required to be discriminated from one another, the vibration application units 40a, 40b, 40c, 40d, and 40e are referred to as vibration application units 40.

The steering system 30 controls a direction of movement of the vehicle 10. The steering system 30 includes the steering unit 14, a steering control unit 50, and a steering unit sensor 52.

The steering control unit 50 is, for example, a computer such as a microcomputer that includes a hardware processor such as a central processing unit (CPU). The steering control unit 50 controls, by controlling the steering unit 14, a direction of movement of the vehicle 10, based on an instruction from the driving assistance device 42.

The steering unit sensor 52 is, for example, an angle sensor including a Hall element and the like and detects a steering angle that is a rotation angle of the steering unit 14. The steering unit sensor 52 outputs the detected steering angle of the steering unit 14 to the intra-vehicle network 44.

The acceleration system 32 controls acceleration of the vehicle 10. The acceleration system 32 includes the acceleration unit 15, an acceleration control unit 54, and an acceleration unit sensor 56.

The acceleration control unit 54 is, for example, a computer such as a microcomputer that includes a hardware processor such as a central processing unit (CPU). The acceleration control unit 54, by controlling the acceleration unit 15, controls acceleration of the vehicle 10, based on an instruction from the driving assistance device 42.

The acceleration unit sensor 56 is, for example, a position sensor and, when the acceleration unit 15 is an accelerator pedal, detects a position of the acceleration unit 15. The acceleration unit sensor 56 outputs the detected position of the acceleration unit 15 to the intra-vehicle network 44.

The braking system 34 controls deceleration of the vehicle 10. The braking system 34 includes the braking unit 16, a braking control unit 58, and a braking unit sensor 60.

The braking control unit 58 is, for example, a computer such as a microcomputer that includes a hardware processor such as a central processing unit (CPU). The braking control unit 58 controls, by controlling the braking unit 16, deceleration of the vehicle 10, based on an instruction from the driving assistance device 42.

The braking unit sensor 60 is, for example, a position sensor and, when the braking unit 16 is a brake pedal, detects a position of the braking unit 16. The braking unit sensor 60 outputs the detected position of the braking unit 16 to the intra-vehicle network 44.

The transmission system 36 controls a transmission gear ratio of the vehicle 10. The transmission system 36 includes the transmission unit 18, a transmission control unit 62, and a transmission unit sensor 64.

The transmission control unit 62 is, for example, a computer such as a microcomputer that includes a hardware processor such as a central processing unit (CPU). The transmission control unit 62 controls, by controlling the transmission unit 18, the transmission gear ratio of the vehicle 10, based on an instruction from the driving assistance device 42.

The transmission unit sensor 64 is, for example, a position sensor and, when the transmission unit 18 is a shift lever, detects a position of the transmission unit 18. The transmission unit sensor 64 outputs the detected position of the transmission unit 18 to the intra-vehicle network 44.

The vibration application unit 40 applies a vibration to the driver. A plurality of the vibration application units 40 are installed at a plurality of locations in a seat 12b for the driver. The vibration application unit 40 is, for example, an air bag that is capable of transforming the shape of the seat 12b by expanding and contracting with gas such as air. The vibration application unit 40 increases, by expanding, support of the driver by the seat 12b. Thereby, the vibration application unit 40 transmits and applies, by increasing the intensity of pressing force acting on the driver from the seat 12b, a vibration such as a running vibration of the vehicle 10, to the driver. The vibration application unit 40 increases or decreases the intensity of a vibration applied to the driver by way of the intensity of pressing force or supporting force. Note that the vibration application unit 40 may be a vibration device that includes an oscillator such as a piezoelectric element, and is capable of vibrating itself. In this case, the vibration application unit 40 may configure the vibration thereof to be a pseudo vibration reflecting a running state such as a speed of the vehicle 10, an environment such as a road surface condition and weather, an operation of the acceleration unit 15, and the like, and apply the pseudo vibration to the driver.

The driving assistance device 42 is, for example, a computer such as an electronic control unit (ECU). The driving assistance device 42 includes a central processing unit (CPU) 42a, which is an example of a hardware processor, a read only memory (ROM) 42b, a random access memory (RAM) 42c, a display control unit 42d, a sound control unit 42e, and a solid state drive (SSD) 42f. The CPU 42a, the ROM 42b, and the RAM 42c may be integrated into an identical package.

The CPU 42a reads a program stored in a nonvolatile storage device such as the ROM 42b, and performs various types of arithmetic processing and control in accordance with the program. The ROM 42b stores each program, parameters required for execution of the program, and the like. The RAM 42c temporarily stores various types of data used in an operation in the CPU 42a. The display control unit 42d primarily performs data conversion and the like of images for display to be displayed on the display device 22 among arithmetic processing performed in the driving assistance device 42. The sound control unit 42e primarily performs processing of sounds to be output by the sound output device 24 among arithmetic processing performed in the driving assistance device 42. The SSD 42f is a rewritable nonvolatile storage unit and keeps data even when the power to the driving assistance device 42 is turned off.

In the present embodiment, the driving assistance device 42 manages, by causing hardware and software (that is, a program) to collaborate with each other, the whole of control of the driving assistance system 28. Specifically, the driving assistance device 42 controls switching among self-driving in which the driving assistance device 42 controls driving of the vehicle 10, authority transfer in which authority of driving is transferred during switching from the self-driving to manual driving, and manual driving in which a driver drives the vehicle 10. The driving assistance device 42 applies, by controlling the vibration application units 40, vibrations to the driver and puts the driver in an appropriate state during a self-driving period, an authority transfer period, and a manual driving period. Note that details of control of the vibration application units 40 during the respective periods will be described later.

The intra-vehicle network 44 is, for example, a controller area network (CAN) or a local interconnect network (LIN). The intra-vehicle network 44 electrically interconnects the operation input unit 26, the steering system 30, the acceleration system 32, the braking system 34, the transmission system 36, a plurality of the vibration application units 40, and the driving assistance device 42 in such a way that the units, the systems, and the device can transmit and receive signals and information with one another.

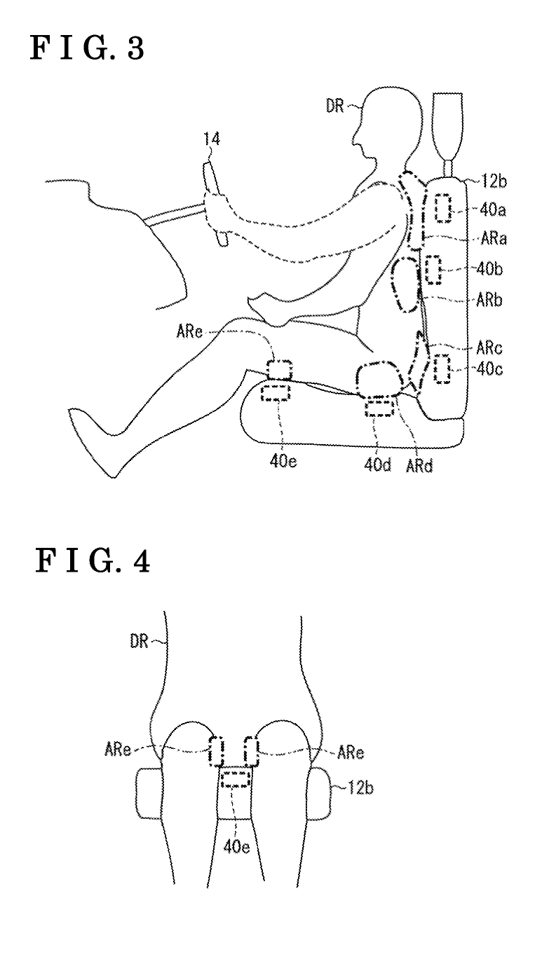

FIG. 3 is a side view describing an arrangement and functions of the vibration application units 40. FIG. 4 is a front view describing the arrangement and the functions of the vibration application units 40.

As illustrated in FIGS. 3 and 4, the vibration application unit 40a is installed in an upper portion of a backrest of the seat 12b. The vibration application unit 40a supports, by expanding the seat 12b and transforming the surface shape thereof, an area ARa covering an upper portion of the back and a cervical portion of a driver DR, and applies a vibration to the area ARa.

The vibration application unit 40b is installed in a central portion in a vertical direction of the backrest of the seat 12b. The vibration application unit 40b supports, by expanding the seat 12b and transforming the surface shape thereof, areas ARb each covering a region from an armpit to a flank (hereinafter, referred to as a flank portion) within a side portion of the driver DR, and applies a vibration to the areas ARb.

The vibration application unit 40c is installed in a lower portion of the seat 12b. The vibration application unit 40c supports, by expanding the seat 12b and transforming the surface shape thereof, an area ARc in a rear surface of the buttocks of the driver DR, and applies a vibration to the area ARc.

The vibration application unit 40d is installed in a rear portion of a seat cushion (or a seating face) of the seat 12b. The vibration application unit 40d supports, by expanding the seat 12b and transforming the surface shape thereof, areas ARd in side surfaces of the buttocks of the driver DR, and applies a vibration to the areas ARd.

The vibration application unit 40e is installed in a front portion of the seat cushion of the seat 12b. The vibration application unit 40e supports, by expanding the seat 12b and transforming the surface shape thereof, areas ARe in inner portions of the thighs of the driver DR, and applies a vibration to the areas ARe.

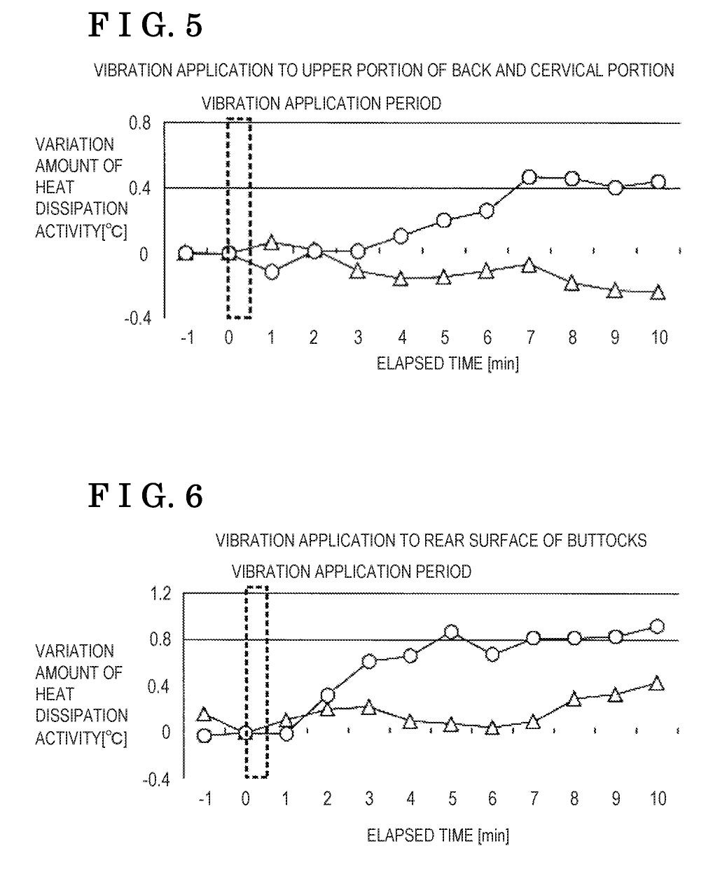

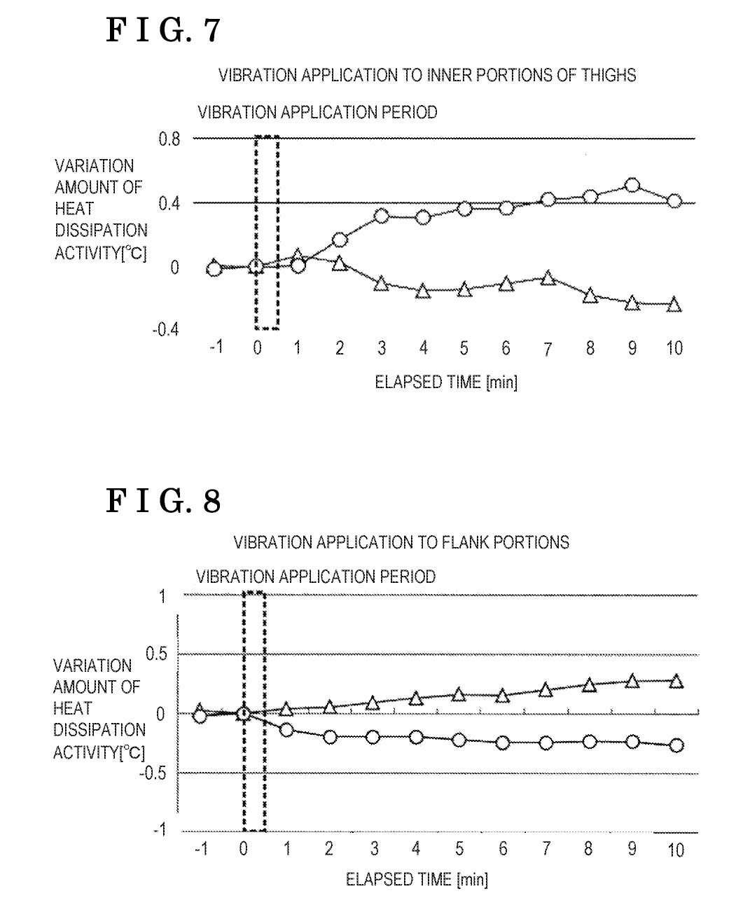

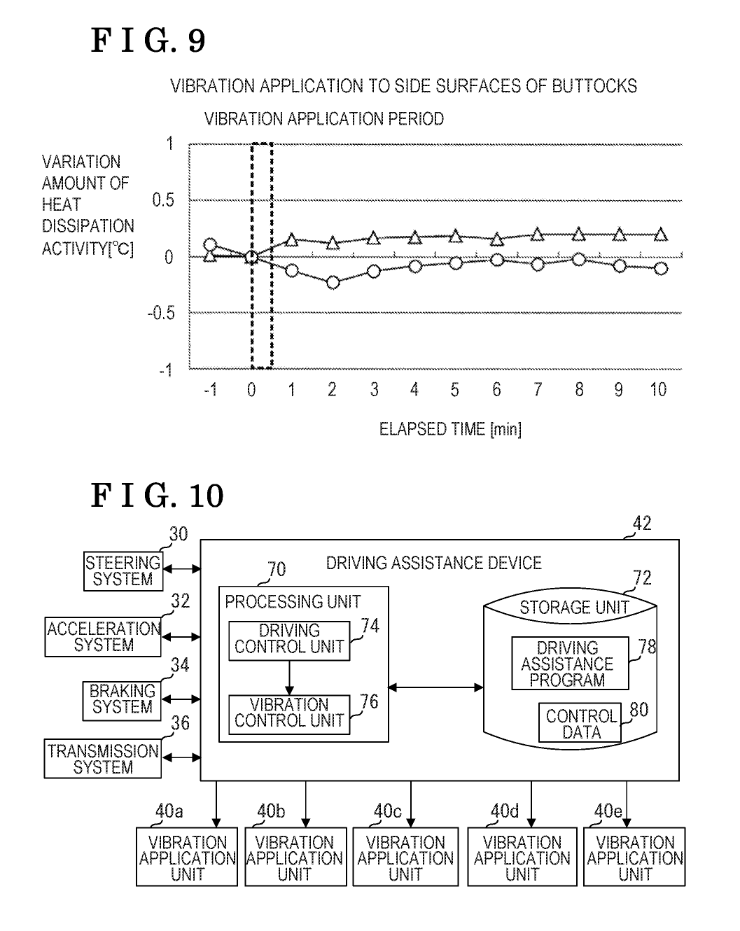

Next, results of experiments on relationships between a region of the driver DR to which a vibration is applied and a variation amount of heat dissipation activity will be described. FIG. 5 is a diagram illustrating a relationship between a vibration applied to an upper portion of the back and a cervical portion of a person and the variation amount of heat dissipation activity. FIG. 6 is a diagram illustrating a relationship between a vibration applied to a rear surface of the buttocks of a person and the variation amount of heat dissipation activity. FIG. 7 is a diagram illustrating a relationship between a vibration applied to inner portions of the thighs of a person and the variation amount of heat dissipation activity. FIG. 8 is a diagram illustrating a relationship between a vibration applied to flank portions of a person and the variation amount of heat dissipation activity. FIG. 9 is a diagram illustrating a relationship between a vibration applied to side surfaces of the buttocks of a person and the variation amount of heat dissipation activity. Note that the variation amount of heat dissipation activity is an increasing or decreasing amount of variation in heat dissipation from a person, and, as the variation amount of heat dissipation activity increases, the heat dissipation from the person is increased to a higher level.

The abscissa and the ordinate in each of FIGS. 5 to 9 represent elapsed time and a magnitude of the variation amount of heat dissipation activity, respectively. In each of FIGS. 5 to 9, white circles and white triangles represent the variation amounts of heat dissipation activity for a person to whom a vibration is applied and a person to whom no vibration is applied, respectively. A section (from a time of 0 seconds to a time of 30 seconds) illustrated with a dotted line in each of FIGS. 5 to 9 is a period of time during which a vibration is applied. In each of the experiments in FIGS. 5 to 7, a vibration having a frequency of 50 Hz is applied for 30 seconds. In each of the experiments in FIGS. 8 and 9, a vibration having a frequency of 100 Hz is applied for 30 seconds.

As illustrated in FIGS. 5 to 7, it becomes apparent that application of vibrations to the area ARa in an upper portion of the back and a cervical portion of a person, the area ARc in a rear surface of the buttocks of the person, and the areas ARe in inner portions of the thighs of the person causes the variation amount of heat dissipation activity to increase compared with a person to whom no vibration is applied. That is, the application of vibrations to the above-described body regions causes the variation amount of heat dissipation activity to increase and heat dissipation to be increased to a higher level, which increases blood flow distributions to peripheral portions (hands, feet, and the like) of the person. It is known that vasomotion reflects autonomic nervous activity of a person and a reduction in sympathetic nervous activity causes dilatation of blood vessels. Application of vibrations to the above-described body regions focusing on such characteristics of vascular response causes sympathetic nervous activity of the person to be reduced, which enables the person to be induced into a state of being relaxed. Hereinafter, the areas ARa, ARc, and ARe are referred to as relaxing areas.

As illustrated in FIGS. 8 and 9, it becomes apparent that application of vibrations to the areas ARb in flank portions of a person and the areas ARd in side surfaces of the buttocks of the person causes the variation amount of heat dissipation activity to decrease compared with a person to whom no vibration is applied. That is, the application of vibrations to the above-described body regions causes the variation amount of heat dissipation activity to decrease and heat dissipation to be suppressed, which decreases blood flow distributions to peripheral portions (hands, feet, and the like) of the person. Therefore, application of vibrations to the above-described body regions focusing on such characteristics of vascular response causes sympathetic nervous activity of the person to be increased, which enables a sense and consciousness of driving to be increased and the person to be induced into a state of being awakened. Hereinafter, the areas ARb and ARd are referred to as awakening areas.

FIG. 10 is a functional block diagram describing functions of the driving assistance device 42. As illustrated in FIG. 10, the driving assistance device 42 includes a processing unit 70 and a storage unit 72.

The processing unit 70 is achieved as, for example, functions of the CPU 42a. The processing unit 70 includes a driving control unit 74 and a vibration control unit 76. The processing unit 70 may, for example, achieve functions of the driving control unit 74 and the vibration control unit 76 by reading a driving assistance program 78 stored in the storage unit 72. A part or all of the driving control unit 74 and the vibration control unit 76 may be configured with hardware such as circuits including application specific integrated circuits (ASICs).

The driving control unit 74 switches control of the vehicle 10 among the self-driving period, the authority transfer period, and the manual driving period. The driving control unit 74, for example, switches control of the vehicle 10 among the self-driving period, the authority transfer period, and the manual driving period in this order.

The driving control unit 74 performs, by controlling driving of the vehicle 10, self-driving during the self-driving period. For example, in the self-driving, the driving control unit 74 sets a route, based on a predetermined condition. The driving control unit 74 drives, by controlling the steering unit 14, the acceleration unit 15, the braking unit 16, and the transmission unit 18 via the control units 50, 54, 58, and 62, based on data acquired from the sensors 52, 56, 60, and 64, respectively, the vehicle 10 along the route.

The driving control unit 74 controls driving of the vehicle 10, considering a period of time that is a period between the self-driving period and the manual driving period and that satisfies a predetermined condition as the authority transfer period. For example, assuming transfer of some of the authority over driving of the vehicle 10 to the driver DR to be a predetermined condition, the driving control unit 74 may consider a period of time satisfying the condition as the authority transfer period. The some of the authority over the driving may be authority over any of the steering unit 14, the acceleration unit 15, the braking unit 16, and the transmission unit 18. Assuming a certain period of time before start of the manual driving period to be a predetermined condition, the driving control unit 74 may consider a period of time satisfying the condition as the authority transfer period.

In the manual driving period to which the authority transfer period is switched, the driving control unit 74 transfers all authority over the steering unit 14, the acceleration unit 15, the braking unit 16, and the transmission unit 18 to the driver DR. Therefore, in the manual driving period, the driver DR drives the vehicle 10.

In each of the self-driving period, the authority transfer period, and the manual driving period, the driving control unit 74 outputs the fact of being in the period to the vibration control unit 76.

The vibration control unit 76 applies vibrations to the driver DR by controlling the vibration application units 40 which apply vibrations to the driver DR. In the application of vibrations, when acquiring any of the fact of being in the self-driving period, the fact of being in the authority transfer period, and the fact of being in the manual driving period from driving control unit 74, the vibration control unit 76 switches vibrations applied to the driver DR, based on control data 80. Specifically, by controlling the vibration application units 40, the vibration control unit 76 switches vibrations applied to the driver DR between the self-driving period and the authority transfer period. For example, by controlling the vibration application units 40, the vibration control unit 76 may switch regions of the driver DR to which vibrations are applied between the self-driving period and the authority transfer period. Alternatively, by controlling the vibration application units 40, the vibration control unit 76 may switch intensities of vibrations applied to the driver DR between the self-driving period and the authority transfer period. The intensity of a vibration is, for example, amplitude of the vibration. By controlling the vibration application units 40, the vibration control unit 76 switches vibrations applied to the driver DR between the authority transfer period and the manual driving period. Specifically, by controlling the vibration application units 40, the vibration control unit 76 may switch intensities of vibrations applied to the driver DR between the authority transfer period and the manual driving period. Data on regions to which vibrations are applied and intensities of vibrations in each period are, for example, included in the control data 80.

The storage unit 72 is achieved as a function of at least any of the ROM 42b, RAM 42c, and SSD 42f. The storage unit 72 may be achieved as a function of a storage device on a network. The storage unit 72 stores a program that the processing unit 70 executes, data required for execution of the program, data generated by execution of the program, and the like. For example, the storage unit 72 stores the driving assistance program 78 that the processing unit 70 executes. The storage unit 72 stores the control data 80 including regions to which vibrations are applied and intensities of vibrations that are required for execution of the driving assistance program 78.

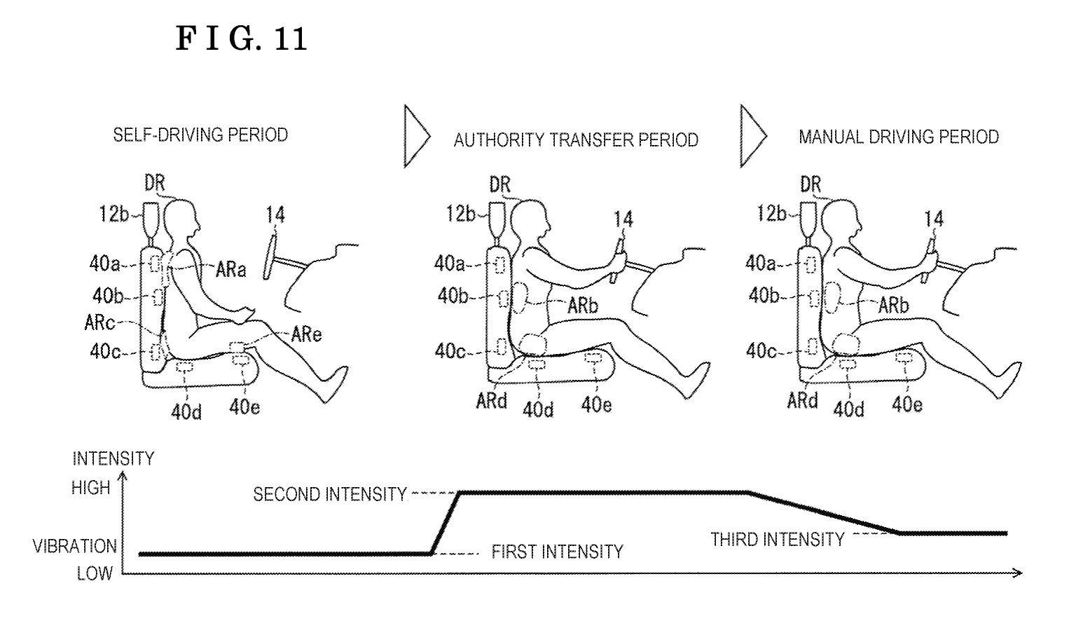

FIG. 11 is a timing diagram describing switching of application of vibrations to the driver DR by the vibration control unit 76.

As illustrated in FIG. 11, during the self-driving period, the vibration control unit 76 applies, by controlling the vibration application units 40a, 40c, and 40e, vibrations to regions located along a central portion of the driver DR. For example, during the self-driving period, the vibration control unit 76 applies, by controlling the vibration application units 40a, 40c, and 40e, a vibration of a first intensity to at least any of the relaxing areas ARa, ARc, and ARe, which correspond to an upper portion of the back and a cervical portion, a rear surface of the buttocks, and inner portions of the thighs, respectively, of the driver DR. Thereby, the vibration control unit 76 is able to cause heat dissipation from a person to be increased and blood flow distributions to peripheral portions of the person to be increased, and consequently induce the person into a state of being relaxed.

During the authority transfer period, the vibration control unit 76 applies, by controlling the vibration application units 40b and 40d, vibrations to regions located along the side portions of the driver DR. For example, during the authority transfer period, the vibration control unit 76 applies, by controlling the vibration application units 40b and 40d, a vibration of a second intensity to at least either of the awakening areas ARb and ARd, which correspond to flank portions and side surfaces of the buttocks, respectively, of the driver DR. The second intensity is, for example, higher than the first intensity. The application of the vibration causes heat dissipation from a person to be suppressed and blood flow distributions to peripheral portions of the person to be decreased, which causes the kinesthetic areas in the brain of the person to be activated and, in particular, the activity of the supplementary motor area to increase. As described above, the vibration control unit 76 may improve awakening of a person by applying vibrations based on a stimulus condition leading to activation of the supplementary motor area, and achieve improvement in both consciousness and concentration toward driving at the same time. In the switching from vibrations applied during the self-driving period to vibrations applied during the authority transfer period, the vibration control unit 76 preferably decreases, instead of abruptly changing vibrations, currently applied vibrations gradually and, at the same time, increases newly applied vibrations gradually.

During the manual driving period, the vibration control unit 76 applies, by controlling the vibration application units 40b and 40d, a vibration of a third intensity to at least either of the awakening areas ARb and ARd, which correspond to flank portions and side surfaces of the buttocks, respectively, of the driver DR. For example, the third intensity is lower than the second intensity, and the first intensity is lower than the third intensity. The application of the vibration causes heat dissipation from a person to be suppressed and blood flow distributions to peripheral portions to be decreased, which enables the person to be awakened. Further, setting the third intensity of the vibration applied during the manual driving period to be lower than the second intensity of the vibration applied during the authority transfer period enables, while causing the driver DR to be awakened, annoyance, discomfort, and the like for the driver DR due to the vibration to be suppressed. In the switching from the intensity of the vibration applied during the authority transfer period to the intensity of the vibration applied during the manual driving period, the vibration control unit 76 preferably decreases, instead of abruptly changing the vibrations, the currently applied vibration gradually. Note that the vibration control unit 76 may gradually decrease the intensity of the vibration to the third intensity when a certain gradual decrease condition is satisfied during the manual driving period. For example, assuming the behavior of the vehicle 10 being stable, the driver DR concentrating on driving, or the like to be a gradual decrease condition, the vibration control unit 76 may gradually decrease the intensity of the vibration to the third intensity when the gradual decrease condition is satisfied. When a position of the steering unit 14 acquired from the steering unit sensor 52 is stable, the vibration control unit 76 may determine that the behavior of the vehicle 10 is stable. In addition, the vibration control unit 76 may determine whether or not the driver DR is concentrating on driving, based on captured images and the like obtained by imaging the inside of the vehicle interior 12a.

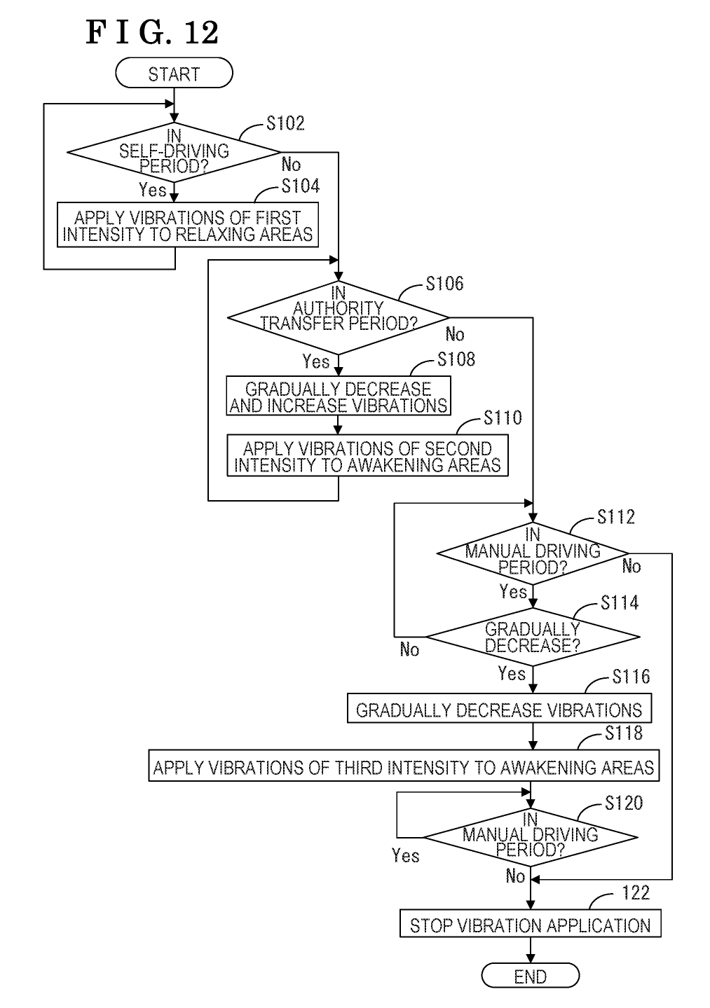

FIG. 12 is a flowchart of driving assistance processing performed by the processing unit 70. The processing unit 70 reads the driving assistance program 78 stored in the storage unit 72 and performs driving assistance processing. The driving assistance processing is an example of a driving assistance method.

As illustrated in FIG. 12, in the driving assistance processing, the driving control unit 74 determines whether or not the vehicle 10 is in the self-driving period (S102). When determining, by controlling the respective control units 50, 54, 58, and 62, that the vehicle 10 is in the self-driving period (Yes in S102), the driving control unit 74 outputs the determination result to the vibration control unit 76. When acquiring a determination result indicating that the vehicle 10 is in the self-driving period from the driving control unit 74, the vibration control unit 76 applies, by controlling the vibration application units 40a, 40c, and 40e, vibrations of the first intensity to the relaxing areas ARa, ARc, and ARe of the driver DR (S104). Subsequently, the driving control unit 74 repeats the processing in and after step S102 during the self-driving period.

When determining that the vehicle 10 is not in the self-driving period (No in S102), the driving control unit 74 determines whether or not the vehicle 10 is in the authority transfer period (S106). When, for example, transferring authority over an operation of at least any of the steering unit 14, the acceleration unit 15, the braking unit 16, and the transmission unit 18 to the driver DR by stopping control of a corresponding one of the control units 50, 54, 58, and 62, the driving control unit 74 determines that the vehicle 10 is in the authority transfer period (Yes in S106) and outputs the determination result to the vibration control unit 76. When acquiring a determination result indicating that the vehicle 10 is in the authority transfer period from the driving control unit 74, the vibration control unit 76 gradually decreases vibrations from the vibration application units 40a, 40c, and 40e and, at the same time, gradually increases vibrations from the vibration application units 40b and 40d by controlling the vibration application units 40b and 40d (S108). The vibration control unit 76 applies, by stopping vibrations from the vibration application units 40a, 40c, and 40e and, in conjunction therewith, maintaining the intensities of vibrations from the vibration application units 40b and 40d at the second intensity, vibrations of the second intensity to the awakening areas ARb and ARd of the driver DR (S110). Subsequently, the driving control unit 74 repeats the processing in and after step S106 during the authority transfer period.

When determining that the vehicle 10 is not in the authority transfer period (No in S106), the driving control unit 74 determines whether or not the vehicle 10 is in the manual driving period (S112). When the driving control unit 74 determines that the vehicle 10, for example, is stopping and is not in the manual driving period (No in S112), the vibration control unit 76 stops application of vibrations (S122) and the driving control unit 74 finishes the driving assistance processing. When transferring authority over an operation of the steering unit 14, the acceleration unit 15, the braking unit 16, and the transmission unit 18 to the driver DR by stopping control of the control units 50, 54, 58, and 62, the driving control unit 74 determines that the vehicle 10 is in the manual driving period (Yes in S112) and outputs the determination result to the vibration control unit 76.

When acquiring a determination result indicating that the vehicle 10 is in the manual driving period from the driving control unit 74, the vibration control unit 76 determines whether or not to gradually decrease vibrations (S114). When, for example, the above-described gradual decrease condition is not satisfied, the vibration control unit 76 determines not to gradually decrease vibrations (No in S114) and, while maintaining the intensities of the vibrations from the vibration application units 40b and 40d, repeats step S112.

When the gradual decrease condition is satisfied, the vibration control unit 76 determines to gradually decrease vibrations (Yes in S114) and, by controlling the vibration application units 40b and 40d, gradually decreases the intensities of vibrations from the present intensities of vibrations (for example, the second intensity) (S116). When the intensities of the vibrations are decreased to the third intensity, the vibration control unit 76 maintains, by controlling the vibration application units 40b and 40d, the intensities of the vibrations to be constant and applies vibrations of the third intensity to the awakening areas ARb and ARd of the driver DR (S118). In other words, in the manual driving period, the vibration control unit 76 reduces the intensities of vibrations applied to the awakening areas ARb and ARd from the second intensity to the third intensity.

The driving control unit 74 determines whether or not the vehicle 10 is in the manual driving period (S120). When determining that the vehicle 10 is in the manual driving period (Yes in S120), the driving control unit 74 transitions to a standby state. Therefore, the vibration control unit 76 continues application of vibrations of the third intensity to the driver DR by means of the vibration application units 40b and 40d. For example, when the vehicle 10 stops and the driving control unit 74 determines that the vehicle 10 is not in the manual driving period (No in S120), the vibration control unit 76 stops application of vibrations (S122) and the driving control unit 74 finishes the driving assistance processing.

As described above, the driving assistance device 42 switches vibrations applied to the driver DR between the self-driving period and the authority transfer period. Thereby, the driving assistance device 42 is able to put the driver DR in an appropriate state during each of the self-driving period and the authority transfer period.

The driving assistance device 42 switches regions of the driver DR to which vibrations are applied between the self-driving period and the authority transfer period. Thereby, the driving assistance device 42 is able to apply vibrations to appropriate regions during each of the self-driving period and the authority transfer period, which enables the driver DR to be put in an appropriate state.

In particular, the driving assistance device 42 applies vibrations to, during the self-driving period, regions located along a central portion of the driver DR that enable the driver DR to be relaxed and, during the authority transfer period, regions located along the side portions of the driver DR that enable the driver DR to be awakened. Thereby, the driving assistance device 42 is able to, during the self-driving period, relax the driver DR and, during the authority transfer period, awaken the driver DR in preparation for the manual driving.

Further, the driving assistance device 42 applies vibrations to, during the self-driving period, an upper portion of the back, a cervical portion, a rear portion of the buttocks, and inner portions of the thighs of the driver DR that have a large effect on relaxing the driver DR and, during the authority transfer period, flank portions and side surfaces of the buttocks of the driver DR that have a large effect on awakening the driver DR. Thereby, the driving assistance device 42 is able to, during the self-driving period, relax the driver DR more certainly and, during the authority transfer period, awaken the driver DR more certainly in preparation for manual driving. When the vibration application units 40 are vibration devices that vibrate themselves, application of vibrations reflecting driving conditions and a surrounding environment of the vehicle 10 enables a gap in somatosensory stimuli to the driver DR to be raised and a sense of transition to the manual driving and a consciousness toward the manual driving of the driver DR to be raised.

In the self-driving period, the driving assistance device 42 may, by applying vibrations to the driver DR at the first intensity which is lower than the second intensity at which vibrations are applied during the authority transfer period, increase quietness inside the vehicle interior 12a and reduce annoyance that the driver DR feels, and consequently further relax the driver DR. In the authority transfer period, the driving assistance device 42 may, by applying vibrations to the driver DR at the second intensity which is higher than the first intensity at which vibrations are applied during the self-driving period, awaken the driver DR more certainly.

In the manual driving period, the driving assistance device 42 may, by applying vibrations to the driver DR at the third intensity which is lower than the second intensity at which vibrations are applied during the authority transfer period, awaken the driver DR moderately while reducing annoyance that the driver DR feels during the manual driving period. In addition, when the manual driving period starts, the driving assistance device 42 may, by gradually decreasing vibrations, further reduce annoyance that the driver DR feels.

In the self-driving period, the driving assistance device 42 may, by applying vibrations to the driver DR at the first intensity which is higher than the third intensity at which vibrations are applied during the manual driving period, further relax the driver DR in the self-driving period.

The functions, the connection relationships, the numbers, the arrangement, and the like of the components in the above-described embodiment may be appropriately changed, deleted, or the like within the scope of the disclosure and the range of equivalency of the scope of the disclosure. The sequence of the respective steps in the embodiment may be appropriately changed.

For example, although, in the above-described embodiment, description has been made taking an example in which a moving object is the vehicle 10, the moving object may at least include a drive source, such as an internal-combustion engine and an electric motor, and be capable of moving itself. The moving object may, for example, be an airplane, a ship, or the like.

Although, in the above-described embodiment, description has been made taking an example in which the driving assistance device 42 switches regions receiving vibrations and intensities of vibrations among the self-driving period, the authority transfer period, and the manual driving period, the present disclosure is not limited to the example. For example, the vibration control unit 76 in the driving assistance device 42 may switch either regions receiving vibrations or intensities of vibrations among the respective periods. Further, the vibration control unit 76 may switch, in conjunction with vibrations, intensities and the like of sounds such as running sounds including engine sounds, among the self-driving period, the authority transfer period, and the manual driving period, and cause the sound output device 24 to output the sounds. For example, the vibration control unit 76 may output, during the self-driving period, sounds of a first volume to the driver DR, during the authority transfer period, sounds of a second volume that is larger than the first volume to the driver DR, and, during the manual driving period, sounds of a third volume that is larger than the first volume and smaller than the second volume to the driver DR.

The vibration application units 40 may be installed at places other than the seat 12b. For example, the vibration application units 40 may be built into the steering unit 14 and the like.

A driving assistance device 42 of this disclosure includes: a driving control unit 74 which switches control of a moving object (vehicle) 10 between a self-driving period for controlling driving of the moving object 10 and an authority transfer period between the self-driving period and a manual driving period during which a driver DR drives the moving object 10; and a vibration control unit 76 which switches, by controlling a vibration application unit 40 which applies a vibration to the driver DR, vibrations applied to the driver DR between the self-driving period and the authority transfer period.

According to the driving assistance device 42 of this disclosure, since the driving assistance device 42 switches vibrations applied to a driver DR between the self-driving period and the authority transfer period, the driving assistance device 42 is able to put the driver DR in an appropriate state during each of the self-driving period and the authority transfer period.

In the driving assistance device 42 of this disclosure, the vibration control unit 76 switches, by controlling the vibration application unit 40, regions of the driver DR to which a vibration is applied between the self-driving period and the authority transfer period.

According to the driving assistance device 42 of this disclosure, the driving assistance device 42 is able to put the driver DR in an appropriate state by applying a vibration to an appropriate region during each of the self-driving period and the authority transfer period.

In the driving assistance device 42 of this disclosure, the vibration control unit 76 applies, by controlling the vibration application unit 40, a vibration to a region located in a central portion of the driver DR during the self-driving period and applies a vibration to regions located in side portions of the driver DR during the authority transfer period.

According to the driving assistance device 42 of this disclosure, the driving assistance device 42 applies a vibration to, during the self-driving period, a region located in a central portion of the driver DR that enables the driver DR to be relaxed and, during the authority transfer period, regions located in side portions of the driver DR that enable the driver DR to be awakened. In this manner, the driving assistance device 42 is able to, during the self-driving period, relax the driver DR and, during the authority transfer period, awaken the driver DR in preparation for manual driving.

In the driving assistance device 42 of this disclosure, the vibration control unit 76 applies, by controlling the vibration application unit 40, a vibration to at least one of an upper portion of a back, a cervical portion, a rear portion of buttocks, and inner portions of thighs of the driver DR during the self-driving period and applies a vibration to at least one of flank portions and side surfaces of buttocks of the driver DR during the authority transfer period.

According to the driving assistance device 42 of this disclosure, the driving assistance device 42 applies a vibration to, during the self-driving period, an upper portion of the back, a cervical portion, a rear portion of the buttocks, and inner portions of the thighs of the driver DR that have a large effect on relaxing the driver DR and, during the authority transfer period, flank portions and side surfaces of the buttocks of the driver DR that have a large effect on awakening the driver DR. In this manner, the driving assistance device 42 is able to, during the self-driving period, relax the driver DR more certainly and, during the authority transfer period, awaken the driver DR more certainly in preparation for manual driving.

In the driving assistance device 42 of this disclosure, the vibration control unit 76 applies, by controlling the vibration application unit 40, a vibration of a first intensity to a region located in a central portion of the driver DR during the self-driving period and applies a vibration of a second intensity which is higher than the first intensity to regions located in side portions of the driver DR during the authority transfer period.

According to the driving assistance device 42 of this disclosure, the driving assistance device 42 is able to, by applying, during the self-driving period, a vibration to the driver DR at the first intensity which is lower than the second intensity at which a vibration is applied during the authority transfer period, reduce annoyance which the driver DR feels and further relax the driver DR. In addition, the driving assistance device 42 is able to, by applying, during the authority transfer period, a vibration to the driver DR at the second intensity which is higher than the first intensity at which a vibration is applied during the self-driving period, awaken the driver DR more certainly.

In the driving assistance device 42 of this disclosure, the driving control unit 74 switches to the manual driving period after the authority transfer period. In addition, the vibration control unit 76 applies, by controlling the vibration application unit 40, a vibration of the second intensity to regions located in side portions of the driver DR during the authority transfer period and applies a vibration of a third intensity which is lower than the second intensity to regions located in side portions of the driver DR during the manual driving period.

According to the driving assistance device 42 of this disclosure, the driving assistance device 42 is able to, by applying, during the manual driving period, a vibration to the driver DR at the third intensity which is lower than the second intensity at which a vibration is applied during the authority transfer period, awaken the driver DR moderately while reducing annoyance which the driver DR feels during the manual driving period.

In the driving assistance device 42 of this disclosure, the vibration control unit 76 applies, by controlling the vibration application unit 40, a vibration of a first intensity to the driver DR during the self-driving period and applies a vibration of a second intensity which is higher than the first intensity to the driver DR during the authority transfer period.

According to the driving assistance device 42 of this disclosure, the driving assistance device 42 is able to, by applying, during the self-driving period, a vibration to the driver DR at the first intensity which is lower than the second intensity at which a vibration is applied during the authority transfer period, reduce annoyance which the driver DR feels and further relax the driver DR. In addition, the driving assistance device 42 is able to, by applying, during the authority transfer period, a vibration to the driver DR at the second intensity which is higher than the first intensity at which a vibration is applied during the self-driving period, awaken the driver DR more certainly.

In the driving assistance device 42 of this disclosure, the driving control unit 74 switches to the manual driving period after the authority transfer period. In addition, the vibration control unit 76 applies, by controlling the vibration application unit 40, a vibration of the second intensity to the driver DR during the authority transfer period and applies a vibration of a third intensity which is lower than the second intensity to the driver DR during the manual driving period.

According to the driving assistance device 42 of this disclosure, the driving assistance device 42 is able to, by applying, during the manual driving period, a vibration to the driver DR at the third intensity which is lower than the second intensity at which a vibration is applied during the authority transfer period, awaken the driver DR moderately while reducing annoyance which the driver DR feels during the manual driving period.

In the driving assistance device 42 of this disclosure, the vibration control unit 76 applies, by controlling the vibration application unit 40, a vibration of a first intensity which is lower than the third intensity to the driver DR during the self-driving period.

According to the driving assistance device 42 of this disclosure, the driving assistance device 42 is able to, by applying, during the self-driving period, a vibration to the driver DR at the first intensity which is lower than the third intensity at which a vibration is applied during the manual driving period, further relax the driver DR during the self-driving period.

A driving assistance method of this disclosure includes: switching control of a moving object (vehicle) 10 between a self-driving period for controlling driving of the moving object 10 and an authority transfer period between the self-driving period and a manual driving period during which a driver DR drives the moving object 10; and, switching vibrations applied to the driver DR between the self-driving period and the authority transfer period by controlling a vibration application unit 40 which applies a vibration to the driver DR.

According to the driving assistance method of this disclosure, since the driving assistance method switches vibrations applied to a driver DR between the self-driving period and the authority transfer period, the driving assistance method is able to put the driver DR in an appropriate state during each of the self-driving period and the authority transfer period.

A computer program product including programmed instructions embodied in and stored on a non-transitory computer readable medium, wherein the instructions, when executed by a computer, cause the computer to perform switching control of a moving object (vehicle) 10 between a self-driving period for controlling driving of the moving object 10 and an authority transfer period between the self-driving period and a manual driving period during which a driver DR drives the moving object 10, and switching vibrations applied to the driver DR between the self-driving period and the authority transfer period by controlling a vibration application unit 40 which applies a vibration to the driver DR.

According to the driving assistance program of this disclosure, since the driving assistance program switches vibrations applied to a driver DR between the self-driving period and the authority transfer period, the driving assistance program is able to put the driver DR in an appropriate state during each of the self-driving period and the authority transfer period.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A driving assistance device comprising:
a driving control unit which switches control of a moving object between a self-driving period for controlling driving of the moving object and an authority transfer period between the self-driving period and a manual driving period during which a driver drives the moving object; and
a vibration control unit which switches, by controlling a vibration application unit which applies a vibration to the driver, vibrations applied to the driver between the self-driving period and the authority transfer period.

2. The driving assistance device according to claim 1, wherein
the vibration control unit switches, by controlling the vibration application unit, regions of the driver to which a vibration is applied between the self-driving period and the authority transfer period.

3. The driving assistance device according to claim 2, wherein
the vibration control unit applies, by controlling the vibration application unit, a vibration to a region located in a central portion of the driver during the self-driving period and applies a vibration to regions located in side portions of the driver during the authority transfer period.

4. The driving assistance device according to claim 3, wherein
the vibration control unit applies, by controlling the vibration application unit, a vibration to at least one of an upper portion of a back, a cervical portion, a rear portion of buttocks, and inner portions of thighs of the driver during the self-driving period and applies a vibration to at least one of flank portions and side surfaces of buttocks of the driver during the authority transfer period.

5. The driving assistance device according to claim 3, wherein
the vibration control unit applies, by controlling the vibration application unit, a vibration of a first intensity to a region located in a central portion of the driver during the self-driving period and applies a vibration of a second intensity which is higher than the first intensity to regions located in side portions of the driver during the authority transfer period.

6. The driving assistance device according to claim 5, wherein
the driving control unit switches to the manual driving period after the authority transfer period, and
the vibration control unit applies, by controlling the vibration application unit, a vibration of the second intensity to regions located in side portions of the driver during the authority transfer period and applies a vibration of a third intensity which is lower than the second intensity to regions located in side portions of the driver during the manual driving period.

7. The driving assistance device according to claim 1, wherein
the vibration control unit applies, by controlling the vibration application unit, a vibration of a first intensity to the driver during the self-driving period and applies a vibration of a second intensity which is higher than the first intensity to the driver during the authority transfer period.

8. The driving assistance device according to claim 7, wherein
the driving control unit switches to the manual driving period after the authority transfer period, and
the vibration control unit applies, by controlling the vibration application unit, a vibration of the second intensity to the driver during the authority transfer period and applies a vibration of a third intensity which is lower than the second intensity to the driver during the manual driving period.

9. The driving assistance device according to claim 8, wherein
the vibration control unit applies, by controlling the vibration application unit, a vibration of a first intensity which is lower than the third intensity to the driver during the self-driving period.

10. A driving assistance method comprising:
switching control of a moving object between a self-driving period for controlling driving of the moving object and an authority transfer period between the self-driving period and a manual driving period during which a driver drives the moving object; and
switching vibrations applied to the driver between the self-driving period and the authority transfer period by controlling a vibration application unit which applies a vibration to the driver.

11. A computer program product including programmed instructions embodied in and stored on a non-transitory computer readable medium, wherein the instructions, when executed by a computer, cause the computer to perform;
switching control of a moving object between a self-driving period for controlling driving of the moving object and an authority transfer period between the self-driving period and a manual driving period during which a driver drives the moving object; and
switching vibrations applied to the driver between the self-driving period and the authority transfer period by controlling a vibration application unit which applies a vibration to the driver.
